(19) United States
(12) Patent Application Publication
(10) Pub. No.: US 2004/0168462 A1
(43) Pub. Date: Sep. 2, 2004

(54) Air conditioning system

(76) Inventor: Gad Assaf, Beer Sheva (IL)

Correspondence Address: BACHMAN & LAPOINTE, P.C., 900 CHAPEL STREET, SUITE 1201, NEW HAVEN, CT, 06510, US

(21) Appl. No.: 10/481,318

(22) PCT Filed: Jun. 30, 2002
(86) PCT No.: PCT/IL02/00532

(30) Foreign Application Priority Data
Jul. 3, 2001 (IL) 144119

(51) Int. Cl. F25D 23/00

(52) U.S. Cl. 62/271

(57) ABSTRACT

The invention provides an air conditioning system for an environment (2) within an enclosure (4), the system including an air/water cooling tower (6) in fluid flow communication, via a heat exchanger (10), with a brine/air heat exchanger (8), and a brine regenerator (16) in fluid flow communication with the brine/air heat exchanger (8), the brine/air heat exchanger (8) having an air outlet to the enclosure (4) and an air inlet.

### FIELD OF THE INVENTION

The present invention relates to air conditioning systems.

### BACKGROUND OF THE INVENTION

In tropical and humid climates, the enthalpy of the environmental air is very high. For example, in such a location the humidity may be 25 gram/kg and temperature 31° C., resulting in air enthalpy of 55 kJ/kg. Thus, fresh air introduces about 40 kJ/kg and 15 grams of water vapor, which results in heating of 40 kW for a fresh air inflow of 1 kg/s. Some 90% of the fresh air load is caused by the humidity.

### DISCLOSURE OF THE INVENTION

It is a broad object of the present invention to provide an air conditioning system using a cooling tower.

It is a further object of the present invention to provide an air conditioning system including a brine regenerator utilizing thermal heat produced by a solar collector, a salt evaporation solar pond, a non-conductive solar pond or a heat source based on waste processing.

Accordingly, the present invention provides an air conditioning system for an environment within an enclosure, comprising an air/water cooling tower in fluid flow communication, via a heat exchanger, with a brine/air heat exchanger; and a brine regenerator in fluid flow communication with said brine/air heat exchanger, said brine/air heat exchanger having an air outlet to said enclosure and an air inlet.

### BRIEF DESCRIPTION OF THE DRAWINGS

The invention will now be described in connection with certain preferred embodiments with reference to the following illustrative figure so that it may be more fully understood.

With specific reference now to the figure in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawing making apparent to those skilled in the art how the several forms of the invention may be embodied in practice.

In the drawing:

FIG. 1 is a schematic diagram of an air conditioning system for an environment within an enclosure, in accordance with the present invention.

### DETAILED DESCRIPTION

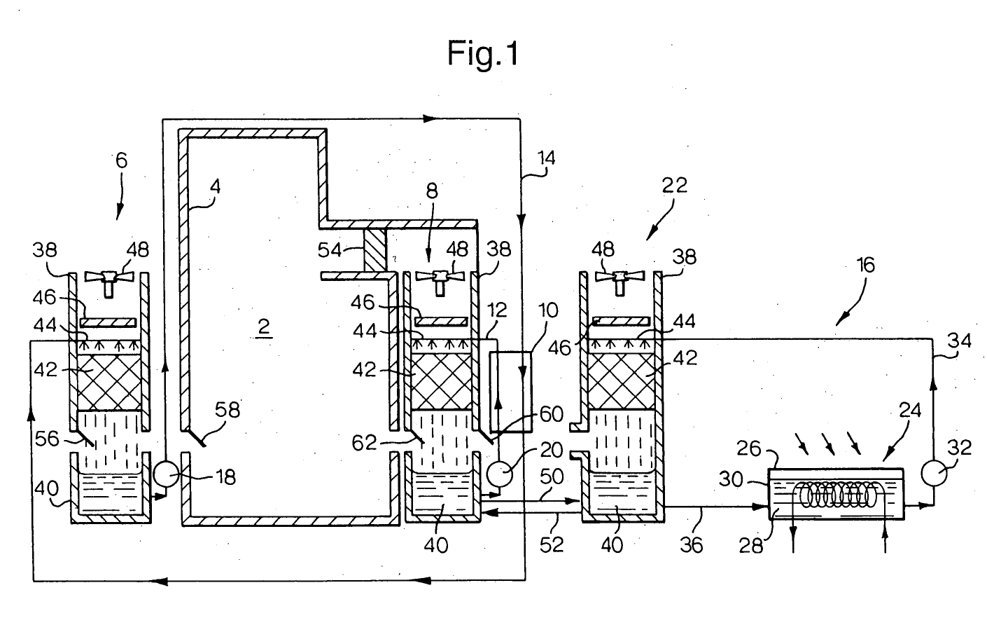

FIG. 1 illustrates a system for air conditioning an environment 2 within an enclosure 4. The system includes an air/water cooling tower 6; a brine/air heat exchanger 8; a heat exchanger 10, e.g., a counter-flow heat exchanger, in thermal fluid communication with the cooling tower 6 via conduits 12, 14, and a brine regenerator 16. The fluid inside conduits 12, 14 is propelled by means of pumps 18, 20.

In the embodiment of FIG. 1, the regenerator 16 is composed of a brine concentrator 22 and a brine heater 24. Brine heater 24 may be constituted by a solar collector 26, a salt evaporator solar pond, a non-conductive solar pond, a source of heat produced by processing waste, or the like, or a combination thereof, all exemplified by the heat exchanging element 28 disposed in a brine reservoir 30, communicating with the brine concentrator by means of a pump 32 and conduits 34, 36.

The cooling tower 6, the brine/air heat exchanger 8 and the brine concentrator 22 are preferably almost identically constructed, having a housing 38, a liquid reservoir 40 at its lower portion, a heat exchanger 42 at its intermediate portion, e.g., a direct contact liquid/air heat exchanger of the type described in the publication WO 00/11426, the teachings of which are incorporated herein by reference.

Above heat exchanger 42 are disposed liquid outlets 44, e.g., sprayers. At the upper portion of housing 38 are located a drift eliminator 46 and a fan 48. Reservoirs 40 of heat exchanger 8 and brine concentrator 22 are in fluid flow communication via conduits 50, 52 for assuring a substantially constant concentration of brine. A humidifier 54 may advantageously be affixed at the outlet of housing 38 of brine concentrator 22, or alternatively, at the inlet to the enclosure 4.

Specifically, the evaporative media of one or more of the cooling tower 6, the heat exchanger 8, or the concentrator 22 is preferably constituted by multi-layered, corrugated cardboard sheets arranged to form a cross-fluted structure having wettable surfaces, an array of inlet openings on a first side of the structure, and an array of outlet openings on a second side of the structure, substantially opposite the first side, in which the hydraulic diameter of the flutes of the structure is less than 1.5 cm, the wettable surface area of the structure is more than 250 m² for every cubic meter thereof, and an air flow is produced within the cross-fluted structure of the evaporative media having a Reynolds number of less than 2,000.

In operation, when the outside wet bulb temperature is low, the environmental air inside enclosure 4 can also be introduced into cooling tower 6 through the openable closure 56. In this mode of operation, the openable closures 58, 60 are closed and the brine cooling tower 6 is used to treat the air within the enclosure 4 through openable closure 62. In another mode of operation, the closures may be partly open to allow air conditioning with fresh air along with air from environment 2 within enclosure 4.

The fresh air enthalpy may be reduced in two stages. In the first stage, the enthalpy reduction is achieved by utilizing the system of FIG. 1, namely, by cooling the brine by means of the water from cooling tower 6 in the heat exchanger 10, thus reducing the air enthalpy in heat exchanger 8. In the second stage, further enthalpy reduction is achieved by an air conditioning system of, e.g., the type described in U.S. Pat. No. 6,018,954, the teachings of which are incorporated herein by reference, in which the brine is further concentrated by the heat of refrigerant condensation. This system is functionally interposed between regenerator 16 and enclosure 4.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. An air conditioning system for an environment within an enclosure, said system comprising:
an air/water cooling tower in fluid flow communication, via a heat exchanger, with a brine/air heat exchanger, and
a brine regenerator in fluid flow communication with said brine/air heat exchanger;
said brine/air heat exchanger having an air outlet to said enclosure and an air inlet.

2. The system as claimed in claim 1, wherein said brine regenerator is composed of a brine concentrator and a brine heater.

3. The system as claimed in claim 2, wherein said brine heater comprises a thermal source selected from the group including a solar collector, a salt evaporation solar pond, a non-conductive solar pond, and a source of heat produced by processing waste.

4. The system as claimed in claim 1, wherein air from said air outlet is introduced into said enclosure via a humidifier.

5. The system as claimed in claim 1, wherein said air/water cooling tower is provided with an air inlet communicating with a first outlet from said enclosure.

6. The system as claimed in claim 1, wherein said air/brine heat exchanger is provided with an air inlet communicating with a second air outlet from said enclosure.

7. The system as claimed in claims 5 and 6, wherein said first and second outlets are closable.

8. The system as claimed in claim 1, wherein said brine/air heat exchanger and said brine regenerator are each provided with a brine reservoir and said reservoirs are in fluid communication with each other.

9. The system as claimed in claim 2, wherein at least one of said cooling tower, said heat exchanger or said concentrator comprises an evaporative media having at least one cross-fluted structure having wettable surfaces composed of multi-layered, corrugated cardboard sheets forming an array of inlet openings on a first side of said structure, and an array of outlet openings on a second side of said structure, substantially opposite the first side, characterized in that:
the Reynolds number of the air flow within said media is less than 2,000.

10. The system as claimed in claim 9, wherein the hydraulic diameter of the flutes of said structure is less than 1.5 cm.

11. The system as claimed in claim 9, wherein the wettable surface area of said structure is more than 250 m² for every cubic meter thereof.

12. An air conditioning system for an environment within an enclosure, substantially as hereinbefore described and with reference to the accompanying drawings.
